(19) United States
(12) Patent Application Publication
(10) Pub. No.: US 2008/0208575 A1
(43) Pub. Date: Aug. 28, 2008

(54) Split-band encoding and decoding of an audio signal

(75) Inventors: Lasse Laaksonen, Nokia (FI); Anssi Ramo, Tampere (FI); Adriana Vasilache, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/712,214

(22) Filed: Feb. 27, 2007

(51) Int. Cl. G10L 19/14

(52) U.S. Cl. 704/225; 704/E19.046

(57) ABSTRACT

For enabling an improved reconstruction of a high frequency band of an audio signal in a split-band coding approach, a value representative of a background noise level in an audio signal that is to be encoded is determined. Further, a gain value for the higher frequency band is determined. Further, a correction factor for the determined gain value is determined based on the determined value representative of the background noise level. The correction factor may be used at an encoding end for correcting the gain value before a corresponding codebook index is provided to a decoding end. Alternatively, the correction factor may be provided together with a codebook index for the gain value to a decoding end, and the decoding end may use the correction factor to correct the gain value if appropriate.

### FIELD OF THE INVENTION

The invention relates in general to a split-band encoding and decoding of an audio signal. It relates more specifically to methods, apparatuses, devices, systems and computer program products supporting such an encoding and decoding.

### BACKGROUND OF THE INVENTION

Audio signals, like speech, are encoded for example for enabling an efficient transmission or storage of the audio signals.

Speech encoders and decoders (codecs) are usually optimized for speech signals, and quite often, they operate with a fixed bit rate.

An audio codec can also be configured to operate with varying bit rates, though. At the lowest bit rates, such an audio codec may work with speech signals as well as a pure speech codec at similar rates. At the highest bit rates, the performance may be good with any signal, including music and background noises, which may be considered as a part of the audio signal instead of just noise.

A further audio coding option is an embedded variable rate speech coding, which is also referred to as a layered coding. Embedded variable rate speech coding denotes a speech coding, in which a bit stream is produced, which comprises primary coded data generated by a core encoder and additional enhancement data, which refines the primary coded data generated by the core encoder. A subset or subsets of the bit stream can then be decoded with good quality. ITU-T standardization aims at a wideband codec of 50 to 7000 Hz with bit rates from 8 to 32 kbps. The codec core will work with 8 kbps and additional layers with quite small granularity will increase the observed speech and audio quality. Minimum target is to have at least five bit rates of 8, 12, 16, 24 and 32 kbps available from the same embedded bit stream.

In a split-band coding approach, different frequency bands of an audio signal are coded separately. Algebraic code excited linear prediction (ACELP) coders employing split-band coding, for example, typically differentiate between a lower frequency band of 50 Hz to 6.4 kHz and a higher frequency band of 6.4 kHz-7 kHz.

Low bit rate wideband speech coders often quantize the lower band as accurately as possible at a given bit rate. Simplified, the parameters obtained in the quantization may be selected for instance such that they can be used at a decoding end to generate an excitation signal and to define a synthesis filter. The synthesis filter can then be applied to the excitation signal to reconstruct the lower band of the audio signal. Then, a decoder reconstructs the higher band of the speech signal based on the lower band excitation or synthesis signal. At bit rates as low as 8 kbps there are generally not enough bits for the high band, and it is therefore approximated on simple rules which are based on the characteristics of the lower-band content of individual speech frames. However, when specialized coding algorithms are used for each speech type, there are sometimes bits available also for the high band without compromising the lower band quality too much. This is in practice the case only for unvoiced speech, where additional high-band coding is thus feasible.

One simple and effective option to improve the naturalness of the wideband signal at low bit rates is to provide a gain value for the higher band defining the desired relation between the energies of the input speech and random noise. For reconstructing the higher band at the decoder, the random noise may be scaled with this gain value to obtain an excitation signal. The excitation signal may then be filtered for example with the same synthesis filter as the lower band signal, which results after band-pass filtering in a good approximation of the actual high band content.

While the reconstruction of a higher band of a speech signal based on a gain value provides good results for clean speech, it sometimes results in a perceptually annoying output in the case of heavy background noise. On the one hand, a noisy signal, which has a lot of high-band content, preserves much of the high-band energy in the output. While this can be annoying during non-active speech segments, the energy can further be given speech-like characteristics during active speech depending on the rule-based processing in the decoder. This can introduce irritating high-frequency distortions to the output. On the other hand, speech classification algorithms more often make an incorrect unvoiced classification under background noise than for clean speech. If the gain based high-band reconstruction is to be used for instance only with unvoiced frames, this classification behavior may further increase the observed high-band noise of the output signal.

Such high band distortions due to background noise could be avoided efficiently by applying noise suppression to the input signal before encoding.

### SUMMARY

The invention proceeds from the consideration that it might not always be desirable to apply noise suppression to an audio signal that is to be encoded. Since noise suppression modifies the speech spectrum, for instance, it can introduce some distortion to the audio signal. While a noise suppressed signal could also be used as side information to determine a suitable gain value for the high band, such an approach would be computationally quite complex.

It would also be possible to control high-band distortions by limiting the gain values in the high-band gain codebook. While this can reduce the number and significance of high-band distortions under background noise conditions, the naturalness of the clean signal is compromised to some extent. This approach implies that a trade-off exists between a clean audio signal performance and a noisy audio signal performance.

For a first aspect of the invention, a method is described, which comprises determining a value representative of a background noise level in an audio signal that is to be encoded. The method further comprises determining a gain value for a higher frequency band of at least two frequency bands of the audio signal. The method further comprises determining a correction factor for the determined gain value based on the determined value representative of the background noise level. This method supports an encoding of an audio signal.

For a second aspect of the invention, a method is described, which comprises determining a gain value for a higher frequency band of at least two frequency bands of an audio signal based on a received codebook index. The method further comprises correcting the determined gain value based on a received correction factor for the gain value. The method further comprises reconstructing the higher frequency band of the audio signal based on the corrected gain value. This method supports a decoding of an audio signal.

For the first aspect of the invention, moreover an apparatus is described, which comprises a determination component configured to determine a value representative of a background noise level in an audio signal that is to be encoded. The apparatus further comprises a determination component configured to determine a gain value for a higher frequency band of at least two frequency bands of the audio signal. The apparatus further comprises a determination component configured to determine a correction factor for the determined gain value based on the determined value representative of the background noise level.

For the second aspect of the invention, moreover an apparatus is described, which comprises a determination component configured to determine a gain value for a higher frequency band of at least two frequency bands of an audio signal based on a received codebook index. The apparatus further comprises a correction component configured to correct the determined gain value based on a received correction factor for the gain value. The apparatus further comprises a reconstruction component configured to reconstruct the higher frequency band of the audio signal based on the corrected gain value.

The components of the described apparatuses can be implemented in hardware and/or software. They may be realized for instance by a processor executing software program code for realizing the required functions. Alternatively, they could be implemented for example in a circuit, for instance in a chipset or a chip, like an integrated circuit. Further, the described apparatuses can comprise only the mentioned components, but they may also comprise various additional components.

Moreover, an electronic device is described, which comprises the apparatus described for the first or the second aspect of the invention and in addition an audio signal interface. For the first aspect of the invention, the audio signal interface can be for instance a microphone or a connector for a microphone, but equally an interface to some other device providing audio signals. For the second aspect of the invention the audio signal interface can be for instance a loudspeaker or a connector for a loudspeaker, but equally an interface to some other device receiving audio signals.

Moreover, a system is described, which comprises the apparatus described for the first aspect of the invention, and in addition another apparatus including a decoding component configured to decode an audio signal encoded by the apparatus described for the first aspect of the invention. The other apparatus can but does not have to correspond to the apparatus described for the second aspect of the invention.

Finally, computer program products are described, in which a respective program code is stored in a computer readable medium. The program code realizes the described method described for the first and/or the second aspect of the invention when executed by a processor. The computer program product could be for example a separate memory device, or a memory that is to be integrated in an electronic device.

The invention is to be understood to cover such computer program codes also independently from a computer program product and a computer readable medium.

In general, it is thus proposed that a high band gain value used in encoding an audio signal is adapted to the noise level in the audio signal based on a corresponding correction factor. While the correction factor is determined at an encoding end, the gain value can be adapted either at the encoding end or at the decoding end. The adapted gain value then enables a reconstruction of the higher frequency band of the audio signal.

The presented approach is suited to improve high-band audio coding during heavy background noise conditions in those cases, in which noise suppression is not desired. At the same time, clean speech performance is not compromised. Further the approach can be implemented with low complexity.

The invention may be employed with any kind of audio signal that is to be encoded using a split-band approach, but in particular with speech signals.

The gain value for the higher frequency band of the audio signal which is to be encoded may be determined in order to specify the influence that the higher frequency band will have in a decoded audio signal.

In one embodiment, the determined gain value for the higher frequency band of the audio signal defines a desired relation between the energies of the audio signal and random noise, which is to be used to reconstruct the high frequency band of the audio signal when decoding the encoded audio signal. The scaled random noise could be used for instance as an excitation signal used for synthesizing the high frequency band of the audio signal.

In one embodiment, a lower frequency band of the audio signal is encoded to obtain parameters enabling a reconstruction of the lower frequency band of the audio signal. The determined gain value for the higher frequency band of the audio signal may then enable a reconstruction of the higher frequency band of the audio signal based on information obtained in the reconstruction of the low frequency band. The information obtained in the reconstruction of the low frequency band could define for instance a filter that is used for filtering an excitation signal for reconstructing the high frequency band of the audio signal.

In one embodiment, the correction factor is determined to be lower in the case of a determined value representing a higher background noise level in the audio signal and wherein the correction factor is determined to be higher in the case of a determined value representing a lower background noise level in the audio signal. Thus, when proceeding from the same originally determined gain value to which the determined correction factor is applied, the higher frequency band will have less influence in the reconstructed audio signal in case of heavy background noise than in the case of a clean audio signal. A correction factor of ‘1’, for instance might not affect the determined gain value to which it is applied, while any correction factor smaller than ‘1’ will correct the determined gain value to which it is applied.

In one embodiment, the correction factor for the determined gain value is determined based on the determined value representative of the background noise level in the audio signal and on a long term background noise level in the audio signal. A low long-term background noise level might compensate for instance to some extent the impact of a currently high background noise level on the correction factor. Considering in addition the long-term background noise level might render transitions from one corrected gain value to the next smoother and thus prevent sudden changes in the decoded audio signal. In an exemplary implementation of this embodiment, an observed signal-to-noise ratio in a respective audio signal frame could be compared against a long-term SNR estimate in order to determine a suitable high-band gain correction factor.

In one embodiment, a signal-to-noise ratio in the audio signal is determined as the value representative of the background noise level in the audio signal. It is to be understood, however, that any other suitable value could be used, like an estimate of the total noise energy in the audio signal.

As indicated above, the correction factor can be applied to a gain value at an encoding end or at a decoding end.

In one embodiment, a codebook index is selected for the determined gain value for the higher frequency band of the audio signal, and this codebook index is provided together with the determined correction factor. Both can be provided for instance for storage or for transmission. When the audio signal is to be decoded again, a gain value may then be selected based on the provided codebook index and corrected by applying the provided correction factor. While this approach requires more bandwidth when providing the encoded audio signal, it enables the decoding end to consider additional criteria when correcting the gain value.

In another embodiment, the determined gain value for the higher frequency band of the audio signal is corrected immediately with the determined correction factor. Then, a codebook index is selected for the corrected gain value. The index can be provided for instance for storage or for transmission. This approach has the advantage that it does not require transmitting any additional parameters to the decoder and that the decoding does not have to be modified.

In one embodiment, the presented approach can be used for instance in the context of high-band gain estimation and transmission in the scope of speech coding. When the background noise is very low or zero, that is, in the case of clean speech, a codebook index giving the best match between the high-band speech and random noise may be searched and transmitted normally. In the presence of background noise, the optimal value may be corrected in accordance with the determined correction factor to avoid producing any annoying high-frequency artifacts in the output signal. This correction factor may be decided based on the long-term noise and the observed noise levels in the current frame. The correction factor can either be transmitted separately or it can be factored into the selected codebook index, if no extra bits are available.

The presented approach can be employed for instance in the scope of a wideband analysis by synthesis CELP based coding using a split band approach, like an adaptive multirate wideband (AMR-WB) speech coding, a variable multi rate wideband (VMR-WB) speech coding or a variable bit rate embedded variable rate (VBR-EV) speech coding. It is to be understood, however, that it can equally be employed with any other coding system using a split band approach.

The electronic device can be for instance a mobile terminal or a personal computer, but equally any other device that is to be used for encoding audio data.

The described approach can be employed for instance for encoding audio signals for transmissions via a packet switched network, for instance for Voice over IP (VoIP), or for transmissions via a circuit switched network, for instance in a global system for mobile communication (GSM). The described approach can also be employed for encoding audio signals for transmissions via other types of networks or for encoding audio signals independently of any transmission.

It is to be understood that the features and steps of all presented embodiments can be combined in any suitable way.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a system according to an embodiment of the invention;

FIG. 2 is a flow chart schematically illustrating a high band encoding operation in the communication system of FIG. 1;

FIG. 3 is a diagram illustrating the principle of the selection of a gain correction factor in accordance with an embodiment of the invention;

FIG. 4 is a diagram illustrating a practical implementation of the selection of a gain correction factor employed in the embodiment of FIG. 1;

FIG. 5 is a flow chart schematically illustrating a high band decoding operation in the communication system of FIG. 1; and

FIG. 6 is a schematic block diagram of an electronic device according to another embodiment of the invention.

### DETAILED DESCRIPTION OF THE INVENTION

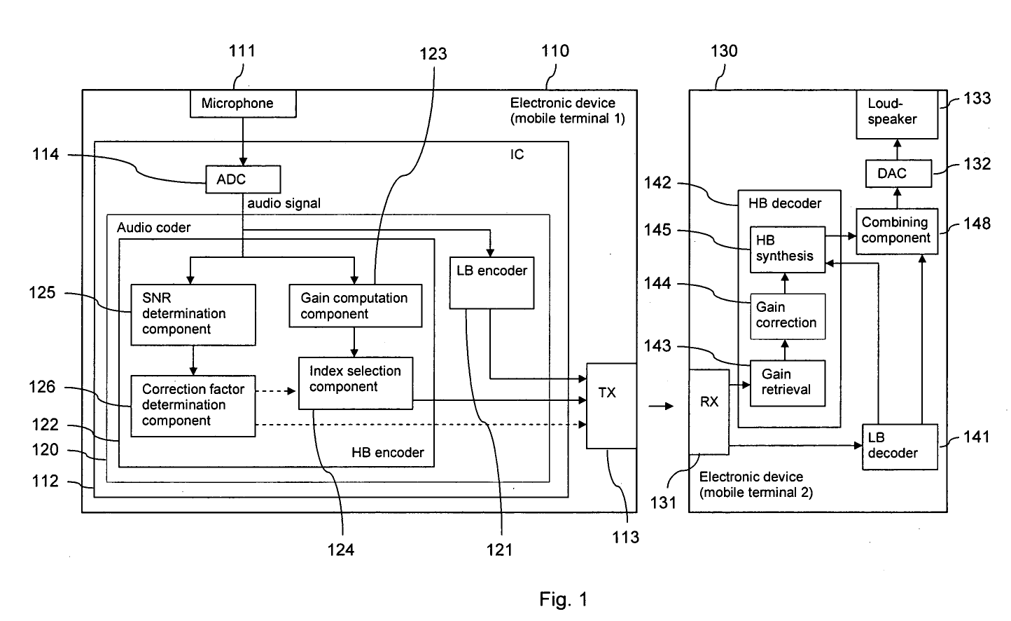

FIG. 1 is a schematic block diagram of a system, which enables a high band gain correction in a split band coding approach in accordance with a first embodiment of the invention.

The system comprises a first electronic device 110 and a second electronic device 130. The system could be for instance a mobile communication system, in which the electronic devices 110, 130 are mobile terminals.

The first electronic device 110 comprises a microphone 111, an integrated circuit (IC) 112 and a transmitter (TX) 113. The integrated circuit 112 or the electronic device 110 could be considered as an exemplary embodiment of the apparatus according to the first aspect of the invention.

The integrated circuit 112 comprises an analog-to-digital converter (ADC) 114 and an audio coder portion 120. The audio coder portion 120 comprises a low-band (LB) encoder portion 121 and a high-band (HB) encoder portion 122. The high-band encoder portion 122 further comprises a gain computation component 123, an index selection component 124, an SNR determination component 125 and a correction factor determination component 126.

The microphone 110 is linked to the analog-to-digital converter 114. The analog-to-digital converter 114 is further linked on the one hand via the low-band encoder portion 121 to the transmitter 113. The analog-to-digital converter 114 is linked on the other hand via the gain computation component 123 and the index selection component 124 to the transmitter 113. Moreover, the analog-to-digital converter 114 is linked to the SNR determination component 125. The SNR determination component 125 is further linked to the correction factor determination component 126, and the correction factor determination component 126 is linked either to the index selection component 124 or to the transmitter 113.

The audio coder 120 could be for example an AMR-WB coder. It could equally be any other kind of coder using a split-band approach, though.

It is to be understood that the electronic device 110 could comprise various other components not shown. The integrated circuit 112 could comprise additional components, too. Further, it is to be understood that the analog-to-digital converter 114 could also be arranged external to the integrated circuit 112 and that the microphone 111 could also be realized in the form of an accessory to the electronic device 110. Moreover, it has to be noted that the depicted components could also be connected to each other via one or more other components of the first electronic device 110.

The second electronic device 130 comprises, linked to each other in this order, a receiver (RX) 131, a decoder, a digital-to-analog converter 132 and loudspeakers 133. The decoder and various other components could be integrated on an integrated circuit. Such an integrated circuit or the electronic device 130 could be considered as an exemplary embodiment of the apparatus according to the second aspect of the invention.

The decoder comprises a low-band decoder portion 141, a high-band decoder portion 142 and a combining component 148. In the high-band decoder portion 142, a gain retrieval component 143 is connected via an optional gain correction component 144 to a high-band synthesis component 145.

The receiver 131 is connected on the one hand to the low-band decoder portion 141 and on the other hand to the gain retrieval component 143 of the high-band decoder portion 142. The low band decoder portion 141 and the high-band synthesis component 145 of the high band decoder portion 142 are both linked via the combining component 148 to the digital-to-analog converter 132. The low band decoder portion 141 is further linked to the high-band synthesis component 145.

It is to be understood that also the electronic device 130 could comprise various other components not shown, and that the loudspeakers 133 could also be realized in the form of an accessory device. Further, it has to be noted that the depicted components could also be connected to each other via one or more other components of the electronic device 130.

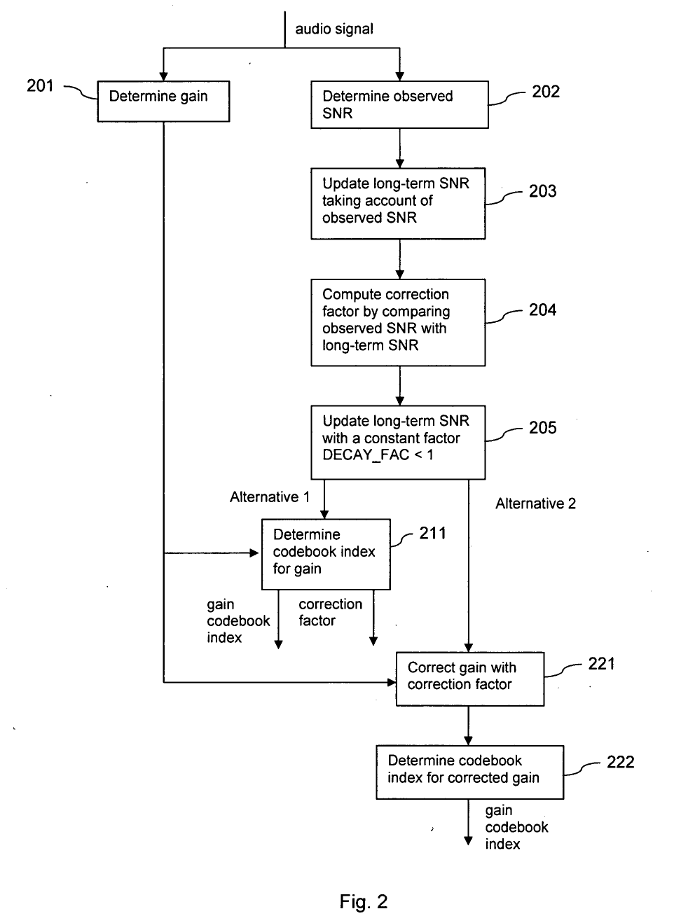

An exemplary operation according to the invention in the system of FIG. 1 will now be described with reference to FIGS. 2 to 5.

A user of the first electronic device 110 may use the microphone 111 for inputting speech that is to be transmitted to the second electronic device 130 via a mobile communication network. The audio signal captured by the microphone 111 will include this speech and in addition any background noise in the surroundings of the device 110.

The analog-to-digital converter 114 converts the analog audio signal received via the microphone 111 into a digital wideband audio signal.

The audio coder 120 receives the digital audio signal from the analog-to-digital converter 114.

Within the audio coder 120, the received audio signal is provided on the one hand to the low-band encoder portion 121 and on the other hand to the high-band encoder portion 122.

The low-band encoder portion 121 quantizes a lower frequency band of the audio signal, for instance a frequency band between 50 Hz and 6.4 kHz, as accurately as possible at a given bit rate and provides the quantized data for transmission. The low-band quantization can be carried out in a conventional manner, for instance as described in document 3GPP TS 26.190, V6.1.0 (2005-06): “Speech codec speech processing functions; Adaptive Multi-Rate—Wideband (AMR-WB) speech codec; Transcoding functions”, (Release 6). The quantized data may comprise for instance linear prediction (LP) parameters, adaptive codebook vector, adaptive codebook gain, fixed codebook vector, fixed codebook gain. Alternatively, for instance, an embedded variable rate speech coder could be used.

FIG. 2 is a flow chart schematically illustrating the processing within the high-band encoder portion 121.

The high-band encoder portion 122 determines on the one hand a gain value for a higher frequency band, for example for a frequency band in the range of 6.4 kHz to 7 kHz (step 201). The gain value is determined by the gain computation component 123 and defines a desired relation between the energies of the input speech and random noise, which will be used at the electronic device 130 to generate an output high-band signal. The gain can be determined for instance in a conventional manner, for example based on a band-pass filtered input signal and a high-band speech synthesis as defined in above mentioned document 3GPP TS 26.190.

On the other hand, the high-band encoder portion 122 determines a gain correction value.

To this end, the SNR determination component 125 determines an observed SNR of the audio signal in order to obtain a value representative of the background noise level in the audio signal (step 202). The signal energy of the audio signal and critical band noise estimates may be calculated in each frame. The total noise energy can then be calculated by adding up the critical band noise estimates. The observed signal-to-noise ration SNR_{observed} may be determined in accordance with the equation:

$${SNR}_{observed} = \frac{{E}_{tot}}{10 log ( {\sum }_{i = min\_band}^{max\_band} {N}_{CB} ( i ) )} ,$$

where Eₜₒₜ is the total energy and where N_{CB}(i) are the critical band noise energy estimates. For details on these values, it is referred to the document 3GPP2 C.S0052-0, Version 1.0, Source-Controlled Variable-Rate Multimode Wideband Speech Codec (VMR-WB), Service Option 62 for Spread Spectrum Systems, Jun. 11, 2004.

Next, the correction factor determination component 126 may update a long-term signal-to-noise ratio SNR_{longterm} of the input audio signal (step 203), for instance based on the following equations:

```
if SNR_{observed} > SNR_{longterm}
    SNR_{longterm} = SNR_{observed}
if SNR_{longterm} > MAX _LONGTERMSNR
    SNR_{longterm} = MAX _LONGTERMSNR
elseif SNR_{longterm} < MIN _LONGTERMSNR
    SNR_{longterm} = MIN _LONGTERMSNR
```

The constant MAX_LONGTERMSNR could be set for instance to a value of 6.0 and the constant MIN_LONGTERMSNR could be set for instance to a value of 2.0.

Now, the correction factor determination component 126 may determine a high-band gain correction factor by comparing the observed SNR in each frame against the updated long-term SNR estimate (step 204).

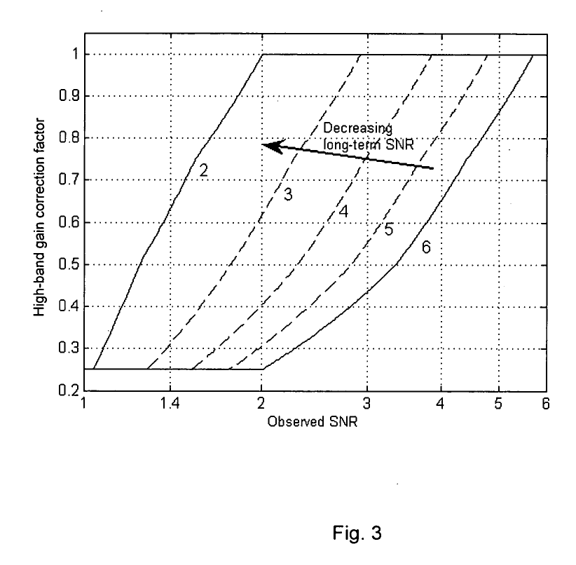

The principle of such a determination is illustrated in FIG. 3. FIG. 3 is a diagram which indicates a high-band gain correction factor, which increases with an increasing observed SNR. The exact relation between the observed SNR and the correction factor depends in addition on the long-term SNR. For a lower longterm SNR, the correction factor increases from a minimum value to a maximum value within a lower range of the observed SNR than for a higher longterm SNR. All SNR values are indicated in dB.

In a practical implementation, a gain correction factor FAC_{HF} could be determined using an approximation of the relations of FIG. 3, for instance based on the following equations:

```
SNRᵣₑₗ = (SNR_{longterm} −MIN _LONGTERMSNR)/(MAX_LONGTERMSNR−MIN_LONGTERMSNR)
if SNR_{observed} < LOWLIMIT_SNR_1+SNRᵣₑₗ*(LOWLIMIT_SNR_2−LOWLIMIT_SNR_1)
    FAC_{HF} = HF _NOISECORR_0
elseif SNR_{observed} < MIDLIMIT_SNR_1+SNRᵣₑₗ*(MIDLIMIT_SNR_2−MIDLIMIT_SNR_1)
    FAC_{HF} = HF _NOISECORR_1
elseif SNR_{observed} < HIGHLIMIT_SNR_1+SNRᵣₑₗ*(HIGHLIMIT_SNR_2−HIGHLIMIT_SNR_1)
    FAC_{HF} = HF _NOISECORR_2
else
    FAC_{HF} = HF _NOISECORR_3
```

The constant LOWLIMIT_SNR_1 could be set for instance to a value of 1.1, the constant LOWLIMIT_SNR_2 could be set for instance to a value of 2.0, the constant MIDLIMIT_SNR_1 could be set for instance to a value of 1.2, the constant MIDLIMIT_SNR 2 could be set for instance to a value of 3.0, the constant HIGHLIMIT_SNR_1 could be set for instance to a value of 1.4 and the constant HIGHLIMIT_SNR_2 could be set for instance to a value of 4.0. Further, the constants HF_NOISECORR_0, HF_NOISECORR_1, HF_NOISECORR_2 and HF_NOISECORR_3 could be set for instance to values 0.25, 0.5, 0.75 and 1, respectively.

These values implement an approximation of the determination of the gain correction factor presented in FIG. 3.

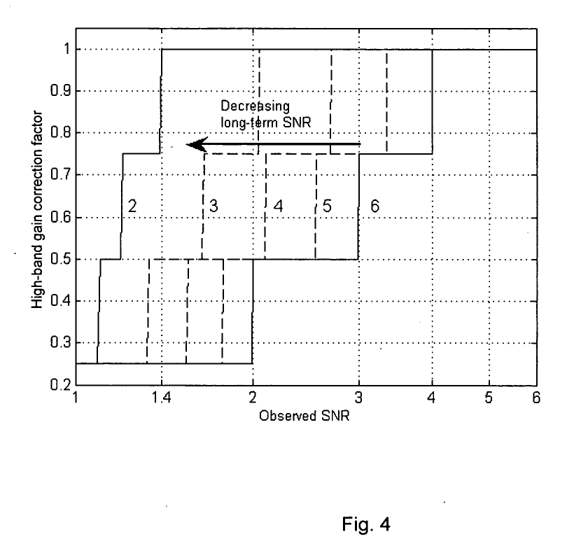

The approximation is also illustrated in FIG. 4. FIG. 4 is again a diagram which indicates a high-band gain correction factor, which increases with an increasing observed SNR with the longterm SNR as an additional parameter. In this case, however, the corrector factor can only assume values of 0.25, 0.5, 0.75 and 1.

Once the correction factor for a frame has been determined, the correction factor determination component 126 may update the long-term signal-to-noise ratio again (step 205), for instance based on the following equation:

SNR_{longterm}=DECAY_{—}FAC*SNR_{kongterm},

where the constant DECAY_FAC is a long-term SNR decay factor. This factor is used to slowly decrease the long-term SNR estimate in order to favor conservative estimates. It can be set for instance to a value of 0.95.

The determined gain correction factor can finally be used in one of two alternatives.

In a first alternative (step 211), the index selection component 124 determines a high-band gain codebook index for the gain determined in step 201. The index is then provided for transmission in addition to the correction factor determined in step 204, which is provided for transmission by the correction factor determination component 126. In the presented embodiment, the gain correction factor can be represented with two bits per frame.

In a second alternative, the index selection component 124 first corrects the gain determined in step 201 with the gain correction factor determined in step 204 (step 221). The correction can be performed simply by multiplying the determined gain with the determined gain correction factor. The strongest impact is achieved with the lowest correction factor of 0.25, which is selected in the case of a low observed SNR. No impact is caused with the highest correction factor of 1.0, which is selected in the case of a high observed SNR.

Only then, the index selection component 124 determines the high-band gain codebook index for the corrected gain (step 222). In this case, only the gain codebook index has to be provided for transmission. It has to be noted that in this second alternative, also the more accurate determination of a gain correction factor as illustrated in FIG. 3 could be employed, since the gain correction factor itself has not to be transmitted.

All data provided by the low band encoder portion 121 and the high-band encoder portion 122 and possibly additional side information are assembled in a single bit stream by an assembly component (not shown). The obtained bit stream is then provided to the transmitter 113. The transmitter 113 transmits the bit stream via a mobile communication network to the second electronic device 130. The receiver 131 of the second electronic device 130 receives the bit stream and provides it to the decoder.

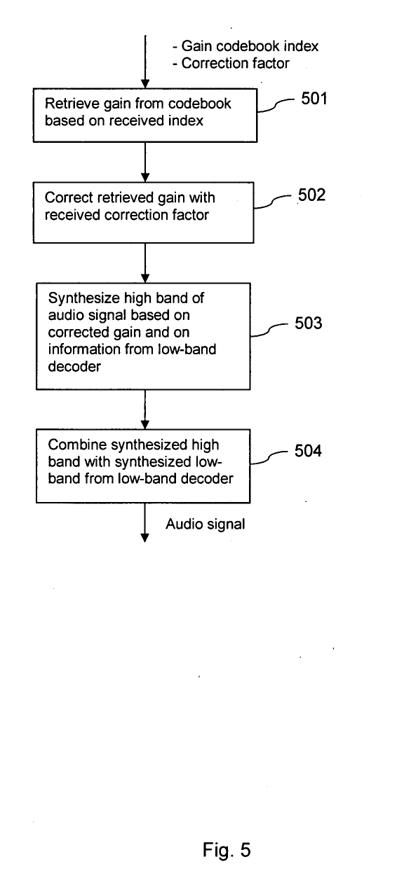

FIG. 5 is a flow chart schematically illustrating the operation at the decoder for the first alternative.

An extraction component (not shown) of the decoder extracts the information from the received bitstream and distributes the low-band data to the low-band decoding portion 141 and the high-band data to the high-band decoding portion 142.

The low-band decoder portion 141 decodes the received parameters and synthesizes the low-band audio signal from the obtained data to obtain the reconstructed speech for instance in a conventional manner, for example as described in above mentioned document 3GPP TS 26.190. Here, an excitation signal is generated based on the decoded parameters, which is then subjected to an LP synthesis filter defined by the decoded LP parameters.

In the high-band decoder 142, the gain retrieval component 143 uses the received high-band gain codebook index for retrieving the gain from a codebook (step 501).

The gain is then provided to the gain correction component 144, which corrects the retrieved gain with the received and decoded gain correction factor (step 502). It has to be noted that the gain correction component 144 could take further information into account when carrying out the correction. For example, if the second electronic device 130 is located in a noisy environment, allowing the use of the original high-band gain may help to maintain the intelligibility of the output.

The corrected gain is then provided to the high-band synthesis component 142, which reconstructs a high-band signal using the corrected gain and information from the low-band decoder portion 141 (step 503). The high-band signal could be reconstructed for example as described in above mentioned document 3GPP TS 26.190. Here, an excitation signal is obtained by scaling white noise filling the upper part of the spectrum with the corrected gain. The excitation signal is then converted to the speech domain by shaping it with a filter derived from the same LP synthesis filter that is used for synthesizing the lower band signal.

The combining component 148 combines the synthesized low-band audio signal and the synthesized high-band audio signal to obtain a decoded digital wideband audio signal (step 504).

For the second alternative, step 502 could simply be omitted, since the received high-band gain is already a corrected high-band gain.

The combined decoded digital audio data is provided to the digital-to-analog converter 132, which converts the digital audio data into analog audio data. The analog audio data may then be presented to a user via the loudspeakers 133.

The functions illustrated by the SNR determination component 125 can also be viewed as means for determining a value representative of a background noise level in an audio signal that is to be encoded. Further, the functions illustrated by the gain computation component 123 can also be viewed as means for determining a gain value for a higher frequency band of at least two frequency bands of the audio signal. Further, the functions illustrated by the correction factor determination component 126 can also be viewed as means for determining a correction factor for the determined gain value based on the determined value representative of a background noise level.

The functions illustrated by the gain retrieval component 143 can also be viewed as means for determining a gain value for a higher frequency band of at least two frequency bands of an audio signal based on a received codebook index. Further, the functions illustrated by the gain correction components 144 can also be viewed as means for correcting the gain value based on a received correction factor for the gain value. Further, the functions illustrated by the high-band synthesis component 145 can also be viewed as means for reconstructing the higher frequency band of the audio signal based on the corrected gain value.

It is to be understood that the embodiment presented with reference to FIG. 1 can be varied in many ways. For instance, all indicated parameter values are only presented by way of example. Further, one or both of the electronic devices 110, 130 could be another device than a mobile terminal. One of the electronic devices could be, by way of example, a personal computer, etc. Further, the functions of the integrated circuits could also be realized by discrete components or by software.

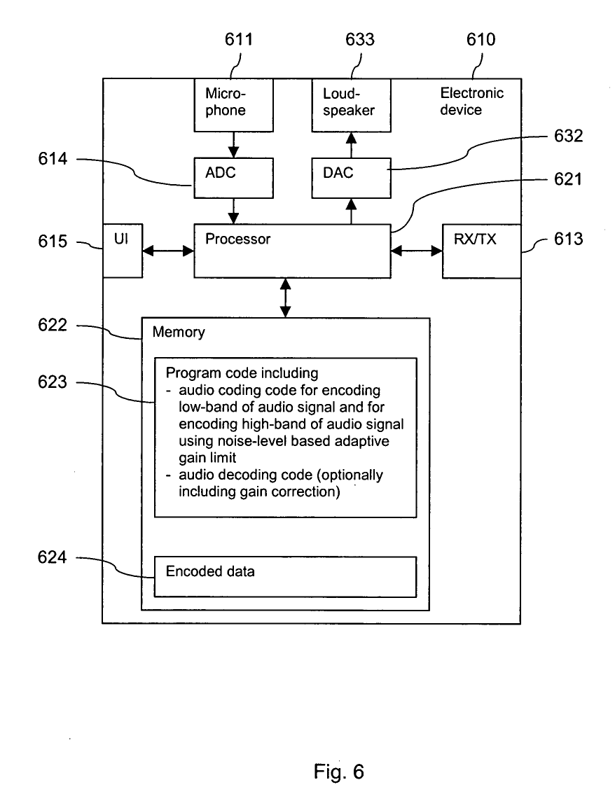

FIG. 6 is a schematic block diagram of an exemplary electronic device 610, which enables a high band gain correction in a split band coding approach in accordance with a second embodiment of the invention.

The electronic device 610 could be again for example a mobile terminal of a wireless communication system. The electronic device 610 could be considered as an exemplary embodiment of the apparatus according to the invention.

It comprises a microphone 611, which is linked via an analog-to-digital converter 614 to a processor 621. The processor 621 is further linked via a digital-to-analog converter 632 to loudspeakers 633. The processor 621 is further linked to a transceiver (TX/RX) 613, to a user interface (UI) 615 and to a memory 622.

The processor 621 is configured to execute various program codes. The implemented program codes comprise an audio encoding code for encoding a lower frequency band of an audio signal and a higher frequency band of an audio signal. The implemented program codes 623 further comprise an audio decoding code. The implemented program codes 623 may be stored for example in the memory 622 for retrieval by the processor 621 whenever needed. The memory 622 could further provide a section 624 for storing data, for example data that has been encoded in accordance with the invention.

The user interface 615 enables a user to input commands to the electronic device 610, for example via a keypad, and/or to obtain information from the electronic device 610, for example via a display. The transceiver 613 enables a communication with other electronic devices, for example via a wireless communication network.

It is to be understood again that the structure of the electronic device 610 could be supplemented and varied in many ways.

A user of the electronic device 610 may use the microphone 611 for inputting speech that is to be transmitted to some other electronic device or that is to be stored in the data section 624 of the memory 622. A corresponding application has been activated to this end by the user via the user interface 615. This application, which may be run by the processor 621, causes the processor 621 to execute the encoding code stored in the memory 622.

The analog-to-digital converter 614 converts the input analog audio signal into a digital audio signal and provides the digital audio signal to the processor 621.

The processor 621 may then process the digital audio signal in the same way as described with reference to FIG. 2 for the electronic device 110 of FIG. 1.

The resulting bit stream is provided to the transceiver 613 for transmission to another electronic device. Alternatively, the coded data could be stored in the data section 624 of the memory 622, for instance for a later transmission or for a later presentation by the same electronic device 610.

The electronic device 610 could also receive a bit stream with correspondingly encoded data from another electronic device via its transceiver 613. In this case, the processor 621 may execute the decoding program code stored in the memory 622. The processor 621 decodes the received data, for instance in the same way as described with reference to FIG. 5 for the electronic device 130 of FIG. 1, and provides the decoded data to the digital-to-analog converter 632. The digital-to-analog converter 632 converts the digital decoded data into analog audio data and outputs them via the loudspeakers 633. Execution of the decoding program code could be triggered as well by an application that has been called by the user via the user interface 615.

The received encoded data could also be stored instead of an immediate presentation via the loudspeakers 633 in the data section 624 of the memory 622, for instance for enabling a later presentation or a forwarding to still another electronic device.

The functions illustrated by the processor 621 executing the encoding code can also be viewed as means for determining a value representative of a background noise level in an audio signal that is to be encoded; means for determining a gain value for a higher frequency band of at least two frequency bands of the audio signal; and means for determining a correction factor for the determined gain value based on the determined value representative of a background noise level.

Alternatively, the functional modules of the encoding code can also be viewed as means for determining a value representative of a background noise level in an audio signal that is to be encoded; means for determining a gain value for a higher frequency band of at least two frequency bands of the audio signal; and means for determining a correction factor for the determined gain value based on the determined value representative of a background noise level.

The functions illustrated by the processor 621 executing the decoding code can also be viewed as means for determining a gain value for a higher frequency band of at least two frequency bands of an audio signal based on a received codebook index; as means for correcting the gain value based on a received correction factor for the gain value; and as means for reconstructing the higher frequency band of the audio signal based on the corrected gain value.

Alternatively, the functional modules of the decoding code can also be viewed as means for determining a gain value for a higher frequency band of at least two frequency bands of an audio signal based on a received codebook index; as means for correcting the gain value based on a received correction factor for the gain value; and as means for reconstructing the higher frequency band of the audio signal based on the corrected gain value.

Summarized, the presented embodiments thus enable an adaptive reduction of a high-band gain value in the presence of background noise. The gain correction results in an improved performance of an audio coding with varying levels of background noise and thus in an improved quality of the reconstructed audio signal.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures.

What is claimed is:

1. A method comprising:
determining a value representative of a background noise level in an audio signal that is to be encoded;
determining a gain value for a higher frequency band of at least two frequency bands of the audio signal; and
determining a correction factor for the determined gain value based on the determined value representative of the background noise level.

2. The method according to claim 1, wherein the determined gain value for the higher frequency band of the audio signal defines a desired relation between the energies of the audio signal and random noise, which is to be used to reconstruct the high frequency band of the audio signal when decoding the encoded audio signal.

3. The method according to claim 1, further comprising encoding a lower frequency band of the audio signal to obtain parameters enabling a reconstruction of the lower frequency band of the audio signal, wherein the determined gain value for the higher frequency band of the audio signal enables a reconstruction of the higher frequency band of the audio signal based on information obtained in the reconstruction of the low frequency band.

4. The method according to claim 1, wherein the correction factor is determined to be lower in the case of a determined value representing a higher background noise level in the audio signal and wherein the correction factor is determined to be higher in the case of a determined value representing a lower background noise level in the audio signal.

5. The method according to claim 1, wherein the correction factor for the determined gain value is determined based on the determined value representative of the background noise level in the audio signal and on a long term background noise level in the audio signal.

6. The method according to claim 1, further comprising determining a signal-to-noise ratio in the audio signal as the value representative of the background noise level in the audio signal.

7. The method according to claim 1, further comprising selecting a codebook index for the determined gain value for the higher frequency band of the audio signal and providing the codebook index together with the determined correction factor.

8. The method according to claim 1, further comprising correcting the determined gain value for the higher frequency band of the audio signal with the determined correction factor, selecting a codebook index for the corrected gain value and providing the selected codebook index.

9. A method comprising:
determining a gain value for a higher frequency band of at least two frequency bands of an audio signal based on a received codebook index;
correcting the determined gain value based on a received correction factor for the gain value; and
reconstructing the higher frequency band of the audio signal based on the corrected gain value.

10. An apparatus comprising:
a determination component configured to determine a value representative of a background noise level in an audio signal that is to be encoded;
a determination component configured to determine a gain value for a higher frequency band of at least two frequency bands of the audio signal; and
a determination component configured to determine a correction factor for the determined gain value based on the determined value representative of the background noise level.

11. The apparatus according to claim 10, wherein the determined gain value for the higher frequency band of the audio signal defines a desired relation between the energies of the audio signal and random noise, which is to be used to reconstruct the high frequency band of the audio signal when decoding the encoded audio signal.

12. The apparatus according to claim 10, further comprising a low-band encoding component configured to encode a lower frequency band of the audio signal to obtain parameters enabling a reconstruction of the lower frequency band of the audio signal, wherein the determined gain value for the higher frequency band of the audio signal enables a reconstruction of the higher frequency band of the audio signal based on information obtained in the reconstruction of the low frequency band.

13. The apparatus according to claim 10, wherein the determination component configured to determine a correction factor is configured to determine the correction factor to be lower in the case of a determined value representing a higher background noise level in the audio signal and to be higher in the case of a determined value representing a lower background noise level in the audio signal.

14. The apparatus according to claim 10, wherein the determination component configured to determine a correction factor is configured to determine the correction factor for the determined gain value based on the determined value representative of the background noise level in the audio signal and on a long term background noise level in the audio signal.

15. The apparatus according to claim 10, wherein the determination component configured to determine a value representative of a background noise level is configured to determine a signal-to-noise ratio in the audio signal as the value representative of the background noise level in the audio signal.

16. The apparatus according to claim 10, further comprising a selection component configured to select a codebook index for the determined gain value for the higher frequency band of the audio signal, wherein the selection component provides the codebook index and the component configured to determine a correction factor provides the determined correction factor.

17. The apparatus according to claim 10, further comprising a correction component configured to correct the determined gain value for the higher frequency band of the audio signal with the determined correction factor, and a selection component configured to select a codebook index for the corrected gain value and to provide the selected codebook index.

18. An electronic device comprising:
an apparatus according to claim 10; and
an audio signal interface.

19. An apparatus comprising:
a determination component configured to determine a gain value for a higher frequency band of at least two frequency bands of an audio signal based on a received codebook index;
a correction component configured to correct the determined gain value based on a received correction factor for the gain value; and
a reconstruction component configured to reconstruct the higher frequency band of the audio signal based on the corrected gain value.

20. An electronic device comprising:
an apparatus according to claim 19; and
an audio signal interface.

21. A system comprising:
an apparatus according to claim 10; and
an apparatus comprising a decoding component configured to decode an audio signal encoded by the apparatus according to claim 10.

22. A computer program product in which a program code is stored in a computer readable medium, said program code realizing the method of claim 1 when executed by a processor.

23. The computer program product according to claim 22, wherein the determined gain value for the higher frequency band of the audio signal defines a desired relation between the energies of the audio signal and random noise, which is to be used to reconstruct the high frequency band of the audio signal when decoding the encoded audio signal.

24. The computer program product according to claim 22, wherein said program code is further configured to encode a lower frequency band of the audio signal to obtain parameters enabling a reconstruction of the lower frequency band of the audio signal, wherein the determined gain value for the higher frequency band of the audio signal enables a reconstruction of the higher frequency band of the audio signal based on information obtained in the reconstruction of the low frequency band.

25. The computer program product according to claim 22, wherein the program code is configured to determine the correction factor to be lower in the case of a determined value representing a higher background noise level in the audio signal and to be higher in the case of a determined value representing a lower background noise level in the audio signal.

26. The computer program product according to claim 22, wherein the program code is configured to determine the correction factor for the determined gain value based on the determined value representative of the background noise level in the audio signal and on a long term background noise level in the audio signal.

27. The computer program product according to claim 22, wherein the program code is configured to determine a signal-to-noise ratio in the audio signal as the value representative of the background noise level in the audio signal.

28. The computer program product according to claim 22, wherein the program code is further configured to select a codebook index for the determined gain value for the higher frequency band of the audio signal and to provide the codebook index together with the determined correction factor.

29. The computer program product according to claim 22, wherein the program code is configured to correct the determined gain value for the higher frequency band of the audio signal with the determined correction factor, to select a codebook index for the corrected gain value and to provide the selected codebook index.

30. A computer program product in which a program code is stored in a computer readable medium, said program code realizing the method of claim 9 when executed by a processor.

31. An apparatus comprising:
means for determining a value representative of a background noise level in an audio signal that is to be encoded;
means for determining a gain value for a higher frequency band of at least two frequency bands of the audio signal; and
means for determining a correction factor for the determined gain value based on the determined value representative of the background noise level.

32. An apparatus comprising:
means for determining a gain value for a higher frequency band of at least two frequency bands of an audio signal based on a received codebook index;
means for correcting the determined gain value based on a received correction factor for the gain value; and
means for reconstructing the higher frequency band of the audio signal based on the corrected gain value.
